(19) United States
(12) Patent Application Publication
(10) Pub. No.: US 2018/0156758 A1
(43) Pub. Date: Jun. 7, 2018

(54) MAGNETOSTRICTIVE COLD SPRAY COATING FOR ENHANCED ULTRASONIC INSPECTION

(71) Applicant: BATTELLE MEMORIAL INSTITUTE, Richland, WA (US)

(72) Inventors: Samuel W. Glass, III, Richland, WA (US); John P. Lareau, Granby, CT (US); Kenneth A. Ross, West Richland, WA (US)

(73) Assignee: BATTELLE MEMORIAL INSTITUTE, Richland, WA (US)

(21) Appl. No.: 15/831,624

(22) Filed: Dec. 5, 2017

Related U.S. Application Data
(60) Provisional application No. 62/430,093, filed on Dec. 5, 2016.

(51) Int. Cl. G01N 29/28; G01N 29/24

(52) U.S. Cl. CPC G01N 29/28; G01N 29/2412

(57) ABSTRACT

An improved process for performing ultrasonic sensing and inspections wherein a cold-spray technique is used to kinetically bond powdered material to a substrate and then an EMAT sensor is magnetically attached to the coating. In use the ultrasound will transfer from the magnetostrictive layer into the substrate more effectively than any glued coating without concerns for long term degradation.

### CLAIM TO PRIORITY

This application claims priority from provisional patent No. 62/430,093 filed by the same applicant and inventors on Dec. 5, 2016. The contents of which are incorporated by reference in their entirety.

### FEDERALLY-SPONSORED RESEARCH AND DEVELOPMENT

This invention was made with Government support under Contract DE-AC05-76RL01830 awarded by the U.S. Department of Energy. The Government has certain rights in the invention.

### BACKGROUND OF THE INVENTION

### Field of the Invention

The present invention relates to sensors and more specifically acoustic sensors for ultrasound inspection systems that function in harsh environments such as areas of high temperatures, pressures, corrosion, radioactivity and so forth.

### Background of the Invention

Ultrasound sensors and inspection systems can generate acoustic waves in metal structures that can be useful in detecting and characterizing cracks, pits, erosion, inclusions, weld anomalies, and other material and structural features. One significant problem with piezoelectric transducers is the difficulty to achieve good coupling between the transducer and the surface being examined, this is particular true in harsh conditions, such as high temperature, cyclic hot and cold temperatures, high radiation associated with nuclear reactors or spent nuclear fuel, highly caustic or corrosive and other extreme condition types of applications, or in long-term monitoring applications where repair or replacement of the sensor is difficult or expensive.

Typically, coupling between the surface and the transducer can be achieved with water, gel, or viscous shear coupling but for long-term applications or in extreme conditions these impedance matching materials wear away, evaporate or are simply unable to function. Fluid couplings can evaporate or drain away from the transducer-substrate interface; glue-based couplings may foul or fail and are notoriously unreliable at high temperatures and in radiation environments. Electromagnetic transducers have also been utilized in some applications wherein an impedance matching magnetostrictive material is glued or adhesively affixed to the item of interest; however in most harsh conditions these also are prone to failure. What is needed therefore is a method and a system for inspecting materials in harsh environments that overcomes the limitations and restrictions presently in place. The present disclosure provides significant advancements in this space.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present disclosure provides various exemplary descriptions of methods and embodiments of sensor arrangements for performing ultrasonic sensing and inspections in extreme conditions. In a broad sense the descriptions center around kinetically bonding powdered material to a substrate using a cold-spray technique to form a magnetostrictive layer and attaching an ultrasonic sensor thereto. This arrangement provides a variety of advantages over the prior art arrangements which as described above have a tendency to degrade or fail when placed in harsh or extreme conditions. In some applications, depending upon the needs of the user, the ultrasonic sensor may be an electromagnetic acoustic transducer, the bonding powdered material preferably contains a material such as nickel or cobalt and has particles with a size between two microns and one-hundred microns. In some applications, the step of kinetically bonding is performed by accelerating a powdered material in a gas to a velocity between 500 to 1500 m/s. In some applications the gas and the powder is heated near the nozzle end of an application device to at least 200 degrees Celsius to facilitate the bonding process. Typically the substrate upon which the materials are bonded is stainless steel, however a variety of other materials are included and anticipated as well.

Once embodied and configured a sensor system having a permanently attached cold-sprayed magnetostrictive layer connected to an item of interest and an Electro-Magnetic Acoustic Transducer (EMAT) sensor operatively to the magneto restrictive layer is formed. These sensor systems can be utilized and placed on a variety of materials and in a variety of embodiments and configurations including a nuclear fuel canister, a pipe, or a structure adapted for exposure to cavitation such as a blade on a hydro-turbine, propeller or other similar article that is exposed to cavitation forces.

In various configurations and embodiments the process for mounting a sensor to an item of interest can be altered and varied to use the cold spray technique to form a variety of functions including but not limited to building up the magnetostrictive layer, building up, filling or covering sensors or to form features adapted for connection with other devices such as covers, standoffs or interconnects which can increase any of a variety of features including but not limited to the durability, capability or interoperability of the sensor device in its particular environment or arrangement.

Various advantages and novel features of the present disclosure are described herein and will become further readily apparent to those skilled in this art from the following detailed description. In the preceding and following descriptions I have shown and described only the preferred embodiment of the disclosure, by way of illustration of the best mode contemplated for carrying out the disclosure. As will be realized, the disclosure is capable of modification in various respects without departing from the disclosure. Accordingly, the drawings and description of the preferred embodiment set forth hereafter are to be regarded as illustrative in nature, and not as restrictive.

### BRIEF DESCRIPTION OF THE DRAWINGS

FIG. 1 shows one example of one embodiment of the present disclosure.

FIG. 2 shows a graph outlining testing results on one embodiment of the present disclosure.

FIGS. 3(a)-3(d) show various example embodiments of the present disclosure.

### DETAILED DESCRIPTION

The present disclosure provides various examples of improved process methods and systems for performing ultrasonic sensing and inspections in a harsh environment. A solution for operating in such a space has been developed wherein applications of cold spray technology are used to bond a magnetostrictive acoustic transducer to a substrate surface to generate ultrasonic guided waves that would probe the substrate for cracks or other faults. This can be performed for example, by using a cold spray technique to metallurgically bond a magnetostrictive layer that can function as an integral part of the magnetostrictive electromagnetic sensor to launch and receive surface and bulk acoustic waves for non-destructive evaluation. This methodology can be performed quickly and cheaply, and could be applied either in the field as a retrograde repair or improvement or at the original manufacturing site. The resulting arrangement is typically a permanent one and won't degrade over time. It also provides a variety of advantages in application and performance particularly in harsh or extreme environments where existing methodologies for connection simply cannot withstand the conditions and subsequently are not used. The use of this invention in applications such as nuclear fuel canisters, oil and gas pipelines (particularly those under sea, buried or in harsh conditions of heat or cold) and similar such environments are envisioned.

In one set of examples described hereafter in more detail, a cold-spray technique was used to kinetically bond powdered material to a substrate to form a coating. While stainless steel is described in the various embodiments the substrate need not be limited solely to stainless steel. A variety of other materials including but not limited to other metallic materials in addition to materials such as applied to polymer based plastics, carbon, glass, or metal fiber reinforced plastics, concrete substrates, or other materials.

An electromagnetic acoustic transducer (EMAT) is then magnetically attached to the coating. In use, the ultrasound will transfer from the magnetostrictive layer into the substrate more effectively than any glued coating without concern for long term degradation or failure of the magnetostrictive material or the substrate bond as a result of the harsh conditions. This arrangement provides a variety of advantages in that it enables for remote sensing of items in locations and environments that were not available previously.

In one set of embodiments a cold spray technique was utilized by accelerating a particle powder (˜2-100 microns) in N2 or He gas to Mach 2 or Mach 3 and impacted onto a substrate achieving a true metallurgical kinetic bond. In some applications, the powder and gas are heated near the nozzle end to several hundred degrees Celsius to facilitate the bonding process; however this additional step is not always required. When the powder impacts the substrate, a metallurgical bond is formed. This cold spray coating may be applied robotically or manually with single or multiple passes, to build up coating layers up to several mm in thickness. Once this coating is in place, an electromagnetic acoustic transducer can be applied and operatively connected so as to provide a signal through the item of interest.

One common cold-spray alloy to overlay onto stainless steel is nickel (Ni). Although best known for its corrosion resistant properties, Ni also has very good magnetostrictive properties and a Curie temperature of 385 degrees C. Permanent magnets may also be operated at these temperatures or higher. The Ni magnetostrictive characteristics may be enhanced with Ni alloys such as chrome, cobalt, and various ferrites. Other materials are also possible to apply via the cold spray process—some of which may have even better properties for enhancing magnetostrictive sensor performance. Examples would include those containing cobalt or iron, in particular Terfenol-D (an iron-terbium-dysprosium alloy) has shown particular promise. While these enumerated materials are provided merely as examples and various substitutions, additions and varied configurations are also contemplated and could be alternatively embodied.

This technique and applications utilizing this technique finds application in a variety of types of deployments including those such as verifying the structural integrity of critical components such as spent or used fuel canisters, components of advanced nuclear or chemical reactors, or buried or exposed pipe that are inaccessible or very difficult to access, such as underwater, underground, concrete encased, or subject to harsh conditions such as heat, cold, hydraulic forces or corrosion. The present technique allows for a sensor system to be put in place that allows for periodic inspection and interrogations from a remote location. In addition this allows such sensors to be effectively permanently installed.

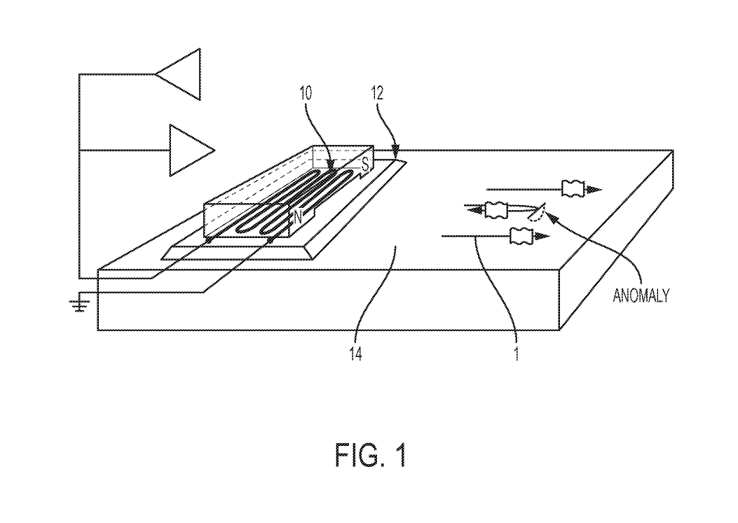

FIG. 1 shows an exemplary arrangement wherein an ultrasound guided wave transducer 10 (preferably an electromagnetic acoustic transducer, EMAT) is placed upon a magnetostrictive layer 12 that has been permanently kinetically bonded to the substrate material of interest 14 through a cold-spray technique. In use, the interaction between a static magnetic field and a transient magnetic field generated by current carrying coils in the EMAT sensor and corresponding eddy currents in a conductive metal layer in close proximity to the sensor coils produces a transient stress in the material. This stress produces an acoustic wave 1 that can travel significant distances in the material of the items of interest 14. The primary wave-form for this acoustic wave 1 depends on the configuration of the EMAT sensor.

As explained in the equations below, generally speaking the stress (f) does not behave linearly as a function of field strength, and is further complicated by magnetic hysteresis effects. Moreover, (f) it is a multi-dimensional spatial and electric field vector equation whose description and solution is beyond this document; however the concepts may be simplified and generalized and described by Maxwell's equations. Specifically (f) is equal to the Lorentz force (fL) plus the magnetostrictive force (fM).

f=fL+fM

Lorentz forces are defined by the eddy current density induced in the metal (Je) and the magnetic flux density (B). Magnetostrictive forces are defined by the gradient in the magnetic field (∇H) [a 3×3 second order tensor whose (I, j) element in Cartesian coordinate space is dHj/dxi.] times the magnetic permeability (μ0) (typically expressed in Henries/meter or H/m or in relative permeability as the dimensionless ratio of μ0/μ_{free-space}) times the magnetic field strength (M).

fL=Je×B fM=∇H·μ0M,

The reciprocal process is exploited to sense variations in the magnetic field as a function of an acoustic strain in accordance with the Villari effect.

Additional factors affecting the sensor performance include the specific magnetostrictive coefficient of the material expressed as a complex ΔL/L tensor in both the direction aligned with the magnetic flux variation and transverse to the magnetic flux. Typically magnetostrictive coefficients are expressed in parts/million or ppm. Some magnetostrictive materials may also be made with a preferential alignment for spatial deformation in accordance with changing magnetic fields. The fM is related to the material's magnetic permeability coupled with other material properties and the understanding that for reasonably high permeable materials, the fM component is significantly more important (bigger) than fL. The acoustic forces are generated quite close (typically within a mm) to the sensor coil. Thus it is only interesting to have a strong magnetostrictive material directly beneath the sensor. The acoustic wave must also traverse the boundary between the two materials with minimal losses. This is aided by having a similar acoustic velocity and a strong bond between the magnetostrictive material and the underlying substrate material so that the acoustic wave propagates from the magnetostrictive layer into the substrate material with minimal losses. The connections described in the present technique assist to enable such an arrangement.

A number of possible candidate materials for a magnetostrictive layer 12 between the EMAT 10 and the material 14 would constitute a significant improvement over the strict Lorentz force based EMAT response in stainless steel, carbon steel, or other substrate materials. A non-comprehensive list of candidate materials includes those in the following table.

TABLE 1
Non comprehensive list of candidate materials for
a cold spray magnetostrictive sensor coating

| | Relative | Magnetostrictive | |
|---|---|---|---|
| Material | Permeability | coefficient (ppm) | Notes |
| Nickel | 100-600 | 25-60 | Can be cold-sprayed plus |
| | | | it has good corrosion |
| | | | behavior. |
| Iron (Fe) | 150-5000 | 11-20 | Poor corrosion resistance |
| Cobolt (Co) | 70-250 | 40-120 | Can be cold-sprayed plus |
| | | | it has good corrosion |
| | | | behavior. |
| Terfenol-D | 9-12 | 800-1200 | Magnetostriction |
| (iron- | | | (PPM) ~1000. Not clear |
| terbium- | | | if this material can be |
| dysprosium | | | sputter-sized for cold |
| alloy) | | | spray. |

The specific embodiment described includes a cold spray magnetostrictive layer applied to the substrate component to be monitored. All anticipated magnetostrictive materials are highly magnetic so the permanent magnet EMAT 10 may simply be placed on the cold spray layer 12 where it will remain in place simply based on its magnetic attraction. If an electro-magnet is to be used, an additional adhesive or mechanical constraint may also be applied to assure the sensor does not move when current is removed from the electromagnet.

The currently intended application is primarily for conductive tanks, canisters, pipes, vessels, and other components where guided wave ultrasound can detect degradation in the structure. It is anticipated that detecting a change or any kind of indication would be followed with a more traditional inspection for disposition and perhaps repair or replacement of the degraded material. Hence in one embodiment a sensor system is described wherein a sensor may be permanently applied to a component (pipe, vessel, tank, etc.) including a cold-spray magnetostrictive layer to enhance the performance of an EMAT sensor for on-line or periodic monitoring of the component.

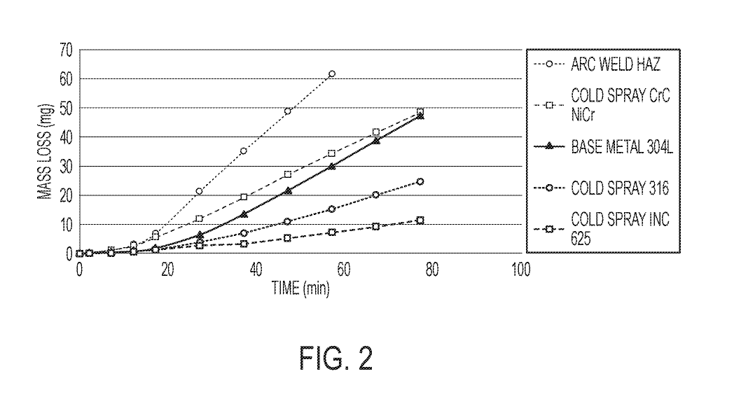

FIG. 2 shows the results of testing performed on sensors installed in a cavitation environment, such as would occur in a harsh hydraulic environment such as a hydroturbine. These tests show that a high velocity cold spray coating of CrC—NiCr, Inconel and stainless steel 316 demonstrated dramatically improved cavitation resistance to baseline stainless steels and arc weld repaired heat affected zones. The dramatic improvements in cavitation performance relative to the baseline stainless steel were unexpected and represent a significant technical advancement in turbine repair. The use of cold spray to create a coating with such high cavitation resistance while maintaining turbine performance is novel and unexpected to those skilled in the art of hydropower materials. Several experts believed there was no spray, or weld repair capable of restoring the performance of the original turbine blades. The data in FIG. 2 demonstrates better results not just a restoration of performance.

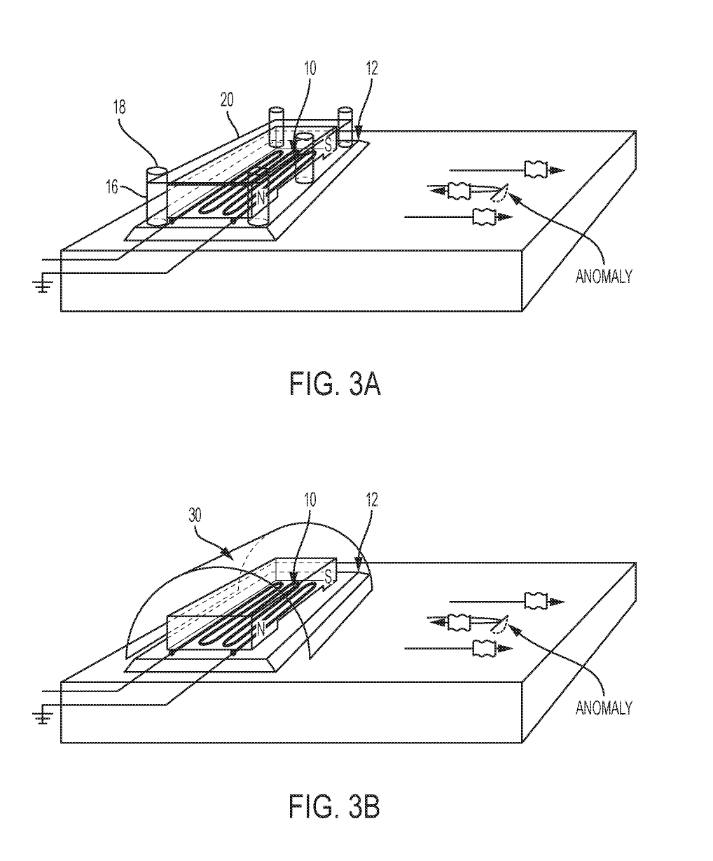

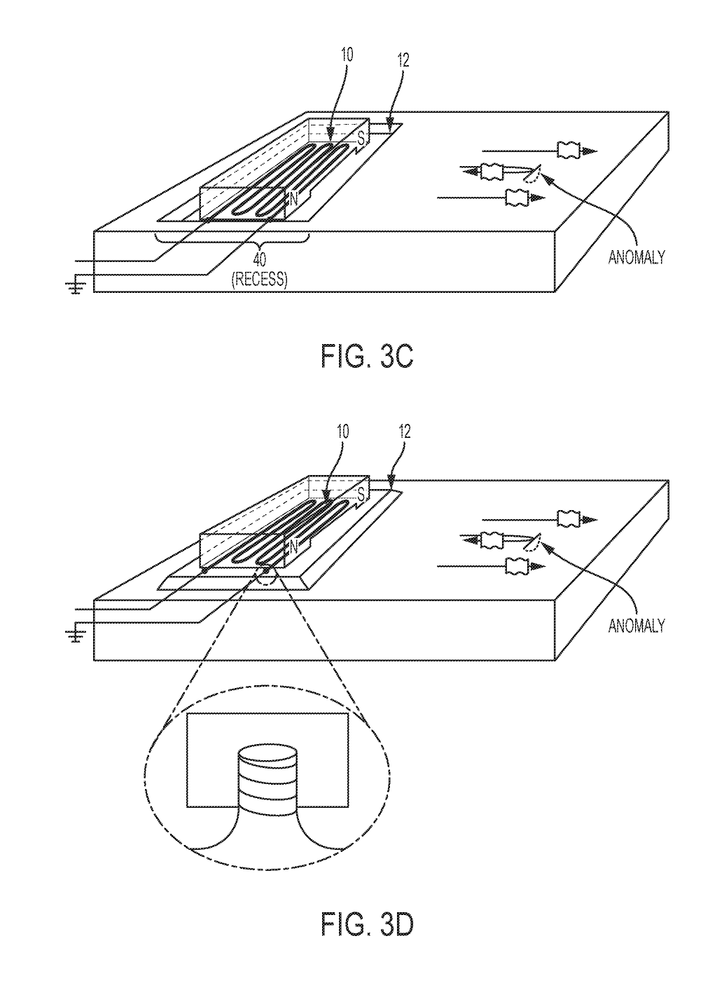

FIGS. 3(a)-3(d) show various other applications where applications the cold spray can be used to build up material 12 around the magnetostrictive layer that can be used as mounting surfaces for a cover to protect the sensor system. One example, shown in FIG. 3(a) would be to build up a standoffs 16 using cold spray around the sensor system and then tap holes 18 in the standoff to enable mounting a cover 20 without tapping or machining the part being monitored. This is a valuable invention because both the sensor itself and mounting features can be installed without removing material from the part being monitored.

For some applications it may be desirable to use cold spray to create an enclosure around the sensor 10. In one instance, a material 12 could be cold sprayed to build up a covering around the sensors, then a cover 20 could be placed over the wall and the cover and wall cold sprayed together. See FIG. 3(b). This would create a durable, fully sealed enclosure 30 around the sensor 10 without damaging or modifying the component to which the sensor is applied. In another instance, shown in FIG. 3(c) a recess 40 could be formed or cut into a component, a sensor 10 installed within the recess 40, then covered 20 and cold sprayed to form an enclosure. In some instances the cold sprayed layer could then be machined or sanded flush with the part surface. Such a technique could allow for inclusion embedding into items such as hydro turbines and other components where disruptions to fluid flow over part surfaces are undesired. In some other applications such as the embodiment shown in FIG. 3(d), the material could be cold sprayed and built up to form a standoff 16 which could be machined to turned to adaptively connect to a compatibly arranged sensor 10 through grooves, threads, or other adaptations.

One advantage that the present description enables is the ability to simultaneously repair a damaged component (such as a hydro turbine) and installing a sensor to monitor the component. Hydro turbines for large hydropower projects are capital investments designed to last for decades. Outages for repair and maintenance can be extremely expensive. The ability to monitor the functional stability would be of significant advantage.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A method for forming a sensor capable of performing ultrasonic sensing and inspections in extreme conditions, the method comprising the step of kinetically bonding powdered material to a substrate using a cold-spray technique to form a magneto restrictive adhesion layer and attaching an ultrasonic sensor to the kinetically bonded material magneto restrictive adhesion layer.

2. The method of claim 1 wherein the ultrasonic sensor is an electromagnetic acoustic transducer.

3. The method of claim 1 wherein the bonding powdered material comprises nickel.

4. The method of claim 1 wherein the bonding powdered material comprises cobalt.

5. The method of claim 1 wherein the powdered material is comprised of particles having a size between two microns to one-hundred microns.

6. The method of claim 1 wherein the step of kinetically bonding includes accelerating a powdered material in a gas to a velocity between 500 to 1500 m/s.

7. The method of claim 6 further comprising the step of heating the gas and the powder near the nozzle end to at least 200 degrees Celsius to facilitate the bonding process.

8. The method of claim 7 wherein the substrate is stainless steel.

9. A sensor system comprising a permanently attached cold-sprayed magnetostrictive layer connected to an item of interest and an EMAT sensor operatively to the magneto restrictive layer.

10. The sensor system of claim 9 wherein the item of interest is a nuclear fuel canister.

11. The sensor system of claim 9 wherein the item of interest is a pipe.

12. The sensor system of claim 9 where the item of interest is a structure adapted for exposure to cavitation.

13. A method for mounting a sensor to an item of interest, the method comprising the steps of kinetically bonding a layer of a powdered material using a cold spray technique to create at least one mounting surface; and mounting the a sensor to the mounting surface.

14. The method of claim 13 wherein the layers of powdered material are deposited in a manner so as to form a feature that covers the sensor.

15. The method of claim 13 further comprising the step of covering the sensor with cold sprayed material.

16. The method of claim 15 wherein a cover is inserted over the sensor prior to being covered with cold sprayed material.

17. The method of claim 15 wherein the surface is within a recessed portion within an item of interest.

18. The method of claim 17 wherein the cold spray covering is deposited so as to fill the recess.

19. The method of claim 13 wherein the mounting surface is developed to form a standoff feature dimensioned for connection to a sensor, thereby enabling connection of a sensor or a cover to the surface without removing material from the item of interest.

20. The method of claim 18 further comprising the step of machining the mounting surface to form at least a portion of the standoff feature.
